(19) United States
(12) Patent Application Publication
(10) Pub. No.: US 2010/0057900 A1
(43) Pub. Date: Mar. 4, 2010

(54) Terminal Apparatus, Server Apparatus, and Method for Managing Installation Position of Communication Equipment

(75) Inventor: Eiji Ootsuka, Kokubunji-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/550,216

(22) Filed: Aug. 28, 2009

(30) Foreign Application Priority Data
Sep. 2, 2008 (JP) 2008-225313

(51) Int. Cl. G06F 15/173

(52) U.S. Cl. 709/223

(57) ABSTRACT

According to one embodiment, a terminal apparatus includes a first acquisition module configured to acquire its own position information by using a known positioning system, a second acquisition module configured to acquire its own position information through another system which is different from the positioning system, when an equipment ID specifying the communication equipment is input at an installation position of the communication equipment and when it is impossible for the first acquisition module to acquire the own position information, and a transmitter which transmits a setting registration request including the equipment ID and the position information to the maintenance center via the communication network, when the transmitter is connectable to the communication network.

### CROSS-REFERENCE TO RELATED APPLICATIONS

This application is based upon and claims the benefit of priority from Japanese Patent Application No. 2008-225313, filed Sep. 2, 2008, the entire contents of which are incorporated herein by reference.

### BACKGROUND

1. Field

One embodiment of the present invention relates to a method for managing an installation position of communication equipment for use in a maintenance service for communication equipment such as an Internet Protocol (IP)-private branch exchange (PBX), and a terminal apparatus and a server apparatus for executing the method.

2. Description of the Related Art

In recent years, an IP telephone system for interactively transmitting/receiving images and audio as packet data in real time via the Internet has become widely used. This IP telephone system can perform extension communication and out side line outgoing call/incoming call among IP-PBXs via the Internet as well as inter-extension communication and out side line outgoing call/incoming call for each IP-PBX connected to the Internet.

Meanwhile, in the IP-PBX, it is desired for operation confirmation and maintenance for installed equipment to be remotely implemented via a communication network such as the Internet. In recent years, a technique which can remotely and easily perform maintenance of an operation and a setting change for data setting of the equipment has become developed.

However, even if an equipment trouble occurrence can be remotely detected, when position information of the installed equipment cannot be clearly detected, or when the position is wrongly detected, the conventional technique requires man-hours for specifying the installation position of the equipment, it poses deterioration in service and the cost-push in the maintenance in addition to a problem such that the time until the trouble is resolved cannot be reduced.

Conventionally, a method, which provides a global positioning system (GPS) receiver for a printer and transmits position information acquired by means of the GPS receiver to a server installed in a maintenance center as the printer is connected to a personal computer, has been proposed (e.g., Jpn. Pat. Appln. KOKAT Publication No. 2006-195509).

However, since the technique of the above requires to additionally connect the GPS receiver to electronic equipment such as a printer, it poses the cost-push, and it becomes impossible to transmit the position information to the maintenance center from the installation position such as the inside of a building and under the ground where a GPS signal cannot be received.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view of a communication system for implementing a first embodiment of a method for managing an installation position of communication equipment of the invention;

FIG. 2 is an exemplary block diagram depicting a configuration of a mobile terminal shown in FIG. 1;

FIG. 3 is an exemplary view depicting map information downloaded from a site on a network in the first embodiment of the invention;

FIG. 4 is an exemplary block diagram depicting a configuration of a maintenance server shown in FIG. 1;

FIG. 5 is an exemplary view depicting an example of a correspondence table generated by means of the maintenance server;

FIG. 6 is an exemplary flowchart depicting an operation procedure and its content of the mobile terminal in the first embodiment of the invention;

FIG. 7 is an exemplary flowchart depicting an operation procedure and its content of the maintenance server in the first embodiment of the invention; and

FIG. 8 is an exemplary block diagram depicting a mobile terminal in a second embodiment of the invention.

### DETAILED DESCRIPTION

Various embodiments according to the invention will be described hereinafter with reference to the accompanying drawings. In general, according to one embodiment of the invention, a terminal apparatus connectable to a maintenance center, via the communication network, wherein the center is connected to communication equipment via a communication network and performs maintenance work for the communication equipment, comprising: a first acquisition module configured to acquire its own position information by using a known positioning system; a second acquisition module configured to acquire its own position information through another system which is different from the positioning system, when an equipment ID specifying the communication equipment is input at an installation position of the communication equipment and when it is impossible for the first acquisition module to acquire the own position information; and a transmitter which transmits a setting registration request including the equipment ID and the position information to the maintenance center via the communication network so that the maintenance center manages the equipment ID and the position information by associating them with each other, when the transmitter is connectable to the communication network.

### First Embodiment

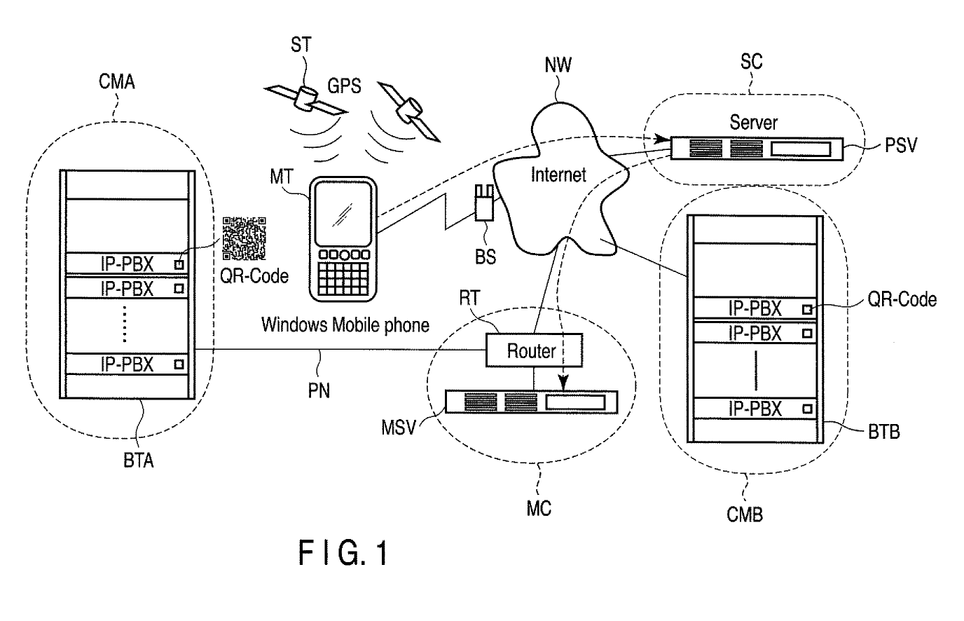

FIG. 1 shows a schematic configuration view of a communication system for implementing a first embodiment of a method for managing an installation position of communication equipment of the invention. The communication system includes user systems CMA and CMB; a service providing center of an exchange manufacturer SC, a maintenance center of the exchange manufacturer MC, and a mobile terminal MTA. Among of them, the mobile terminal MTA is used by being carried by a maintenance person of the exchange manufacturer.

The system is provided for a plurality of base stations distributed and arranged in a service area. To simplify the description of the communication system, FIG. 1 shows only one base station BS. The base station BS forms a wireless area called a cell, and the base station BS is connected through a wireless line to the mobile terminal MTA existing in this wireless area.

The base station BS is connected to a network NW including a telephone/mobile phone public network and the Internet. The user system CMB, the service providing center SC, and the maintenance center MC are connected to the network NW.

The user system CMA includes IP-PBX equipment BTA. The IP-PBX equipment BTA has a function of exchanging and connecting among a plurality of telephone terminals (not shown) and among the telephone terminals and subscriber lines of the public network (not shown) in response to outgoing/incoming calls. The IP-PBX equipment BTA is connected to the maintenance center MC through a private line PN.

The user system CMB has IP-PBX equipment STB in the same way as that of the user system CMA. The IP-PBX equipment BTB is connected to the service providing center SC and the maintenance center MC via the network NW.

The service providing center SC includes a position registration server PSV. The registration server PSV is connected to the network NW to communicate information related to the registration of the IP-PBX equipment BTA, BTB to and from the mobile terminal MTA. The registration server PSV transfers a registration request of the installation positions of the IP-PBX equipment BTA, BTB received from the mobile terminal MTA to the maintenance center MC via the network NW.

The maintenance center MC is provided with a maintenance server MSV and a router RT. The maintenance server MSV remotely performs maintenance for the IP-PBX equipment BTA through the router RT and the private line PN. The maintenance server MSV remotely performs maintenance of the IP-PBX equipment BTB through the router RT and the network NW.

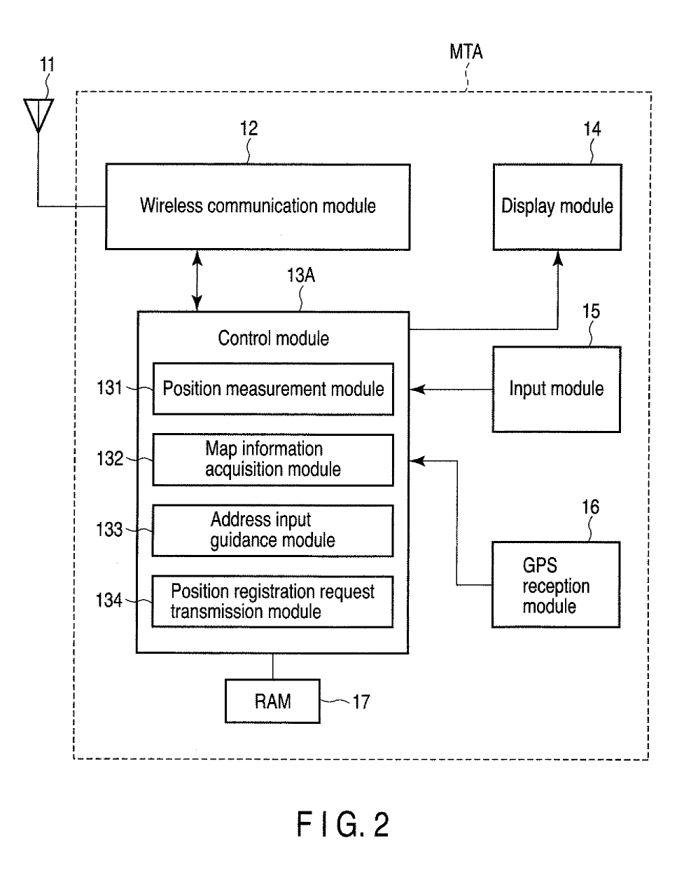

Meanwhile, the mobile terminal MTA is composed in the following manner. FIG. 2 shows a block diagram illustrating the configuration.

The mobile terminal MTA is provided with a wireless communication module 12, a control module 13A, a display module 14, an input module 15, a GPS reception module 16 and a RAM 17. Among of them, the input module 15 is used for inputting various operation instructions to the control module 13A, and is also used for inputting a registration instruction of the installation position of the IP-PBX equipment BTA to the service providing center SC.

The GPS reception module 16 receives a signal from a GPS satellite ST to provide the received signal to the control module 13A.

In addition to a usual control function regarding operations of wireless communication connection, according to the instruction input from a user, the control module 13A includes a position measurement module 131, a map information acquisition module 132 (acquisition module 132), an address input guidance module 133 (guidance module 133), and a position registration request transmission module 134 (request transmission module 134).

The measurement module 131 generates position information showing a current position of the mobile terminal MTA from the received signal obtained by the GPS reception module 16.

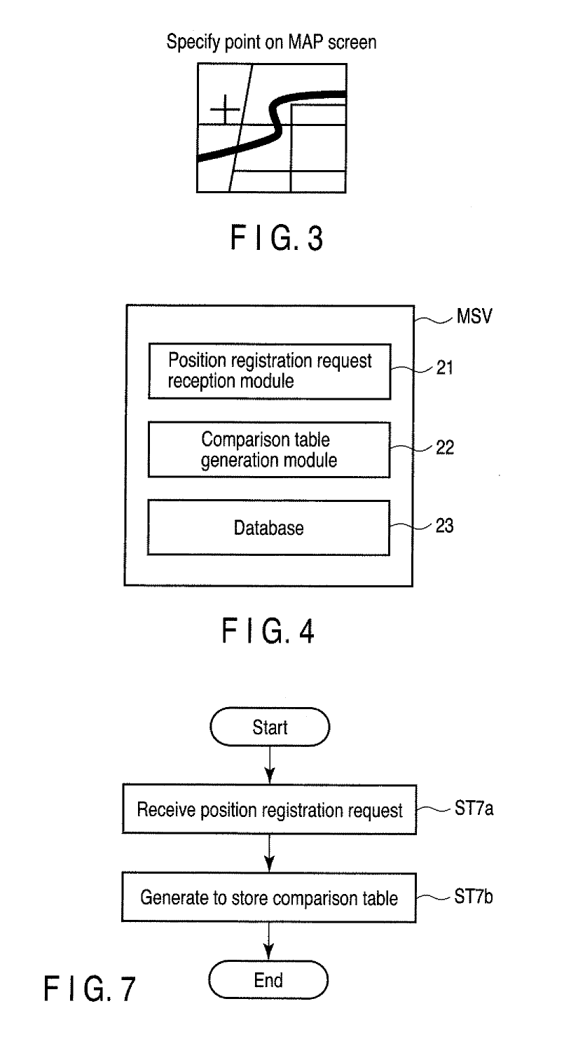

The acquisition module 132 activates an application of “installation position registration” of the IP-PBX equipment BTA. Then, in a case where a QR code as equipment identification information given to the IP-PBX equipment BTA is input, and also in a case where the position information cannot be acquired by means of the GPS reception module 16, the acquisition module 132 controls the wireless communication module 12 so as to access a map providing site (not shown) on the network NW, downloads map information of the surroundings of the installation position of the IP-PBX equipment BTA from the site, and displays the map information on the display module 14 as shown in FIG. 3.

When it is determined that the map information is not acquired through the acquisition module 132, the guidance module 133 displays a message of the fact and guidance information for prompting a maintenance person to input the address of the installation position of the IP-PBX equipment BTA.

When the QR code and the installation position information of the IP-PBX equipment BTA can be acquired, the transmission module 134 stores a position registration request including the QR code and the installation position information of the IP-PBX equipment BTA in the RAM 17. When being connectable to the network NW, the transmission module 134 controls the wireless communication module 12 to access the service providing center SC, and transmits the position registration request stored in the RAM 17 to the service providing center SC through the base station BS and via the network NW.

Meanwhile, the foregoing maintenance server MSV is composed as follows. FIG. 4 shows a block diagram illustrating the configuration.

The maintenance server MSV is provided with a position registration request reception module 21 (request reception module 21), a correspondence table generation module 22 (table generation module 22), and a database 23. Among of them, the request reception module 21 receives a position registration request transferred from the service providing center SC via the network NW.

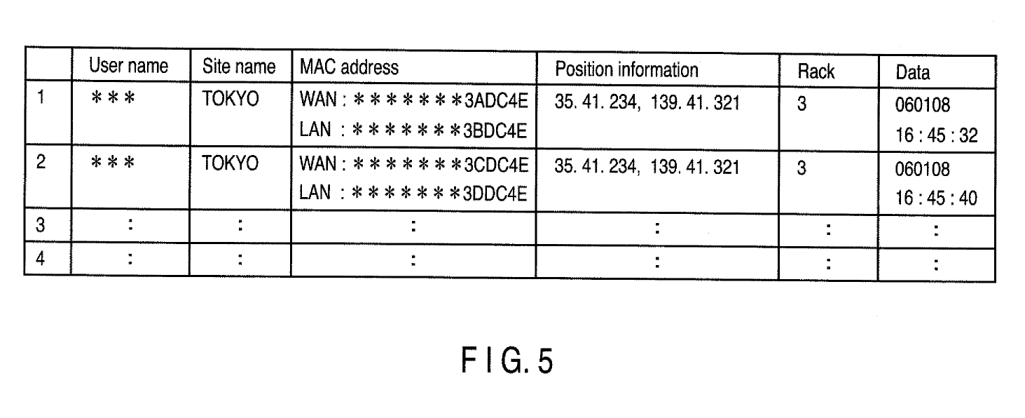

The generation module 22 obtains media access control (MAC) address, a rack number and an installation position in the rack of the IP-PBX equipment BTA from the QR code included in the position registration request. The generation module 22 then generates a correspondence table in which the MAC address, the rack number and the installation position in the rack are associated with the installation position of the IP-PBX equipment BTA to store the table in the database 23 as shown in FIG. 5.

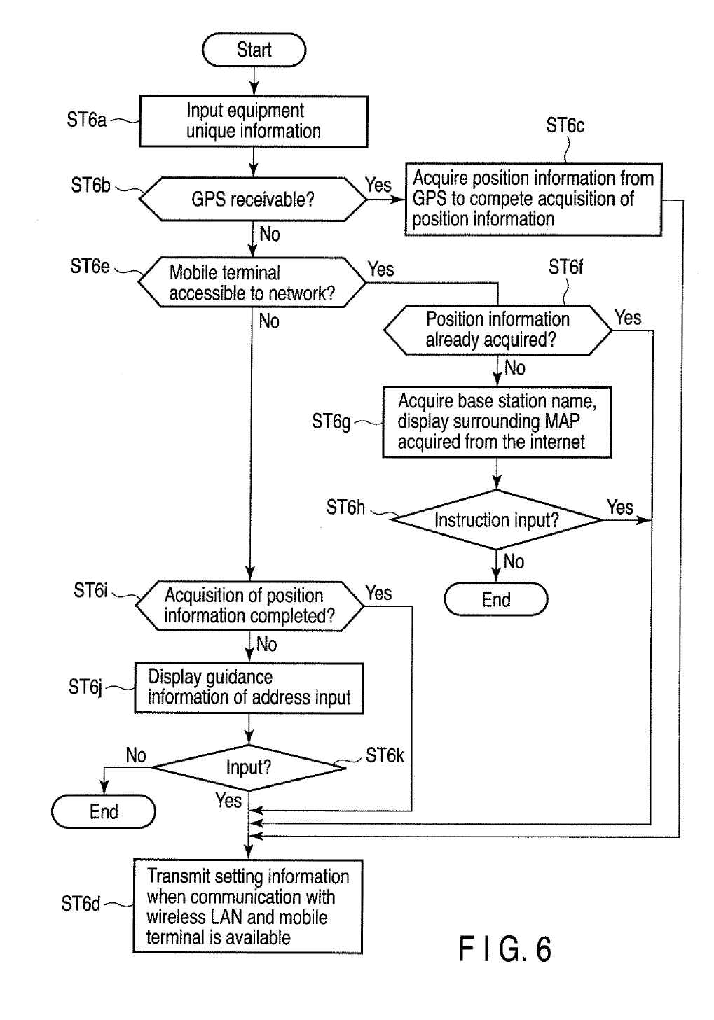

Operations of a communication system composed as mentioned above will be described. FIG. 6 shows a flowchart depicting the operation procedure and its content of the mobile terminal MTA.

For instance, it is assumed that the maintenance person uses the mobile terminal MTA at the installation position of the IP-PBX equipment BTA of the user system CMA so as to register the installation position to the service providing center SC. At this time, it is assumed that the mobile terminal MTA has activated the application of the “installation position registration”. In this state, when the maintenance person uses the input module 15 in order to read and input the QR code prepared in a cabinet of the IP-PBX equipment BTA, the mobile terminal MTA shifts from Block ST6a to Block ST6b, the mobile terminal MTA shifts from Block ST6a to Block ST6b to determine whether or not the GPS signal is receivable there. For instance, if the QR code has been read, since the QR code can record 4,464 alphanumeric characters therein, the mobile terminal MTA can code a URL of the position registration server PS.

Here, if the signal from the GPS satellite ST has been received (YES, Block ST6b), the mobile terminal MTA generates the position information of the mobile terminal MTA from the received signal (Block ST6c), and stores the position information in the RAM 17. When the mobile terminal MTA can access the network NW, the mobile terminal MTA accesses the service providing center SC to transmit the position registration request including the QR code and the position information stored in the RAM 17 to the service providing center SC (Block ST6d).

Conversely, if the signal from the GPS satellite ST has not been received (No, Block ST6b), the mobile terminal MTA determines whether or not it is accessible to the base station BS (Block ST6e). Here, if the mobile terminal MTA is accessible to the base station BS (YES, Block ST6e), the mobile terminal MTA determines whether or not the installation position information of the IP-PBX equipment BTA is stored in the RAM 17 (Block ST6f), and if the position information is not stored (NO, Block ST6f), the mobile terminal MTA receives report information transmitted from the base station BS to extract information showing an absolute position transmitted from the base station BS. The mobile terminal MTA then accesses a map proving site on the network NW based on the extracted position information, and downloads the map information of the surroundings of the installation position of the IP-PBX equipment BTA from the site to display the map information on the display module 14 (Block ST6g). Thereby, the maintenance person may know the installation position of the IP-PBX equipment BTA on a screen to be easily viewed through this display.

It is assumed that the maintenance person perfumes an instruction input of the position through the input module 15 in this state. The mobile terminal MTA then shifts from Block ST6h to Block ST6d, and acquires the position information from the site there to store the information in the RAM 17.

If the mobile terminal MTA is not accessible to the base station BS (NO, Block ST6e), the mobile terminal MTA determines whether or not the installation position information of the IP-PBX equipment BTA has been stored in the RAM 17 (Block ST6i), if the position information has not been stored therein (NO, Block ST6i), the mobile terminal MTA displays a message of the fact that the position information cannot be acquired and guidance information for inputting the address of the installation position of the IP-PBX equipment BTA on the display module 14 (Block ST6j). Thereby, the maintenance person may input the address in accordance with the guidance depending on this display.

If the maintenance person inputs the address by means of the input module 15 in this state, the mobile terminal MTA shifts from Block ST6k to Block ST6d to store the position information showing the address input there in the RAM 17.

In Blocks ST6h and ST6k, if the maintenance person does not perform input work after a lapse of a fixed time interval, the communication systems ends its processing.

Meanwhile, FIG. 7 shows a flowchart illustrating the operation procedure of the maintenance server MSV and its content.

When receiving the position registration request transferred from the position registration server PSV (Block ST7a), the maintenance server MSV obtains the MAC address, the rack number and the installation position of the IP-PBX equipment BTA from the QR code included in the position registration request, generates the correspondence table in which the MAC address, the rack number, and the installation position on the rack are associated with the installation position of the IP-PBX equipment BTA to store the table in the database 23 (Block ST7b).

As mentioned above, according to the first embodiment, in a case in which the QR code is firstly input to the mobile terminal MTA at the installation position of the IP-PBX equipment BTA, for example, it is determined whether or not the mobile terminal MTA can receive the signal from the GPS satellite ST. And if it is determined for the signal not to be received, the mobile terminal MTA acquires the map information of the surroundings of the IP-PBX equipment BTA from the site on the network NW, and transmits the position registration request including the position information and the QR code to the maintenance center MC via the network NW and the service providing center SC.

Accordingly, even if the IP-PBX equipment BTA is installed at any installation position, the maintenance person can register the installation position of the IP-PBX equipment BTA to the maintenance center MC without having to get help from somebody by using the position information acquisition function other than the GPS provided for the mobile terminal MTA. Meanwhile, the maintenance center MC may quickly specify the position information of equipment to be made diagnosis of the trouble, thereby, the time required to replace a component for maintenance can be shortened.

According to the first embodiment, in the communication system, the maintenance person can instruct the installation position of the IP-PBX equipment BTA by viewing the map information at every time when the map information of the surroundings of the IP-PBX equipment BTA, thereby, even if the GPS cannot acquire the position information, the registration of the installation position of the IP-PBX equipment BTA in the maintenance center MC can be performed without getting help from somebody by using the map information from the site on the network NW.

Further, according to the first embodiment, in a case where the map information cannot be acquired from the site on the network NW, since the guidance information for inputting the installation of the IP-PBX equipment BTA is presented to the maintenance person without completion of the acquisition processing of the position information, the maintenance person may input the installation position information of the IP-PBX equipment BTA through the screen which is easy to view. Thereby, the maintenance person can reduce man-hours needed to generate the position information and also require the registration of its installation position for the maintenance center MC by simple operations even if the installation position is at any location.

### Second Embodiment

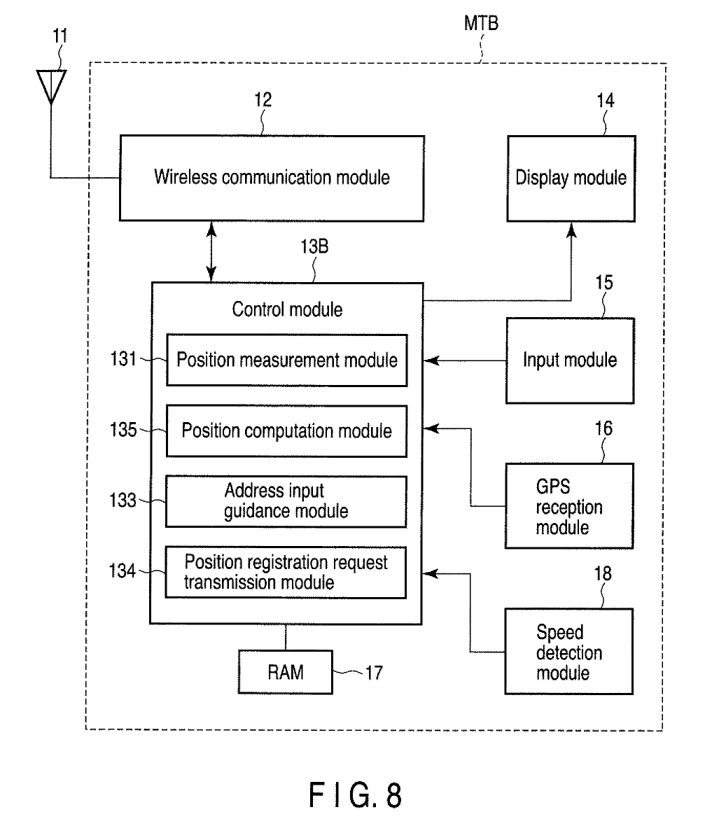

FIG. 8 shows a block diagram illustrating a configuration of a mobile terminal MTB in a second embodiment of the invention. In FIG. 8, components the same as those of FIG. 2 are designated by identical symbols and detailed description of those components will be omitted.

That is, the mobile terminal MTS is provided with a speed detection module 18. The detection module 18 uses, for example, a gyroscope to detect a moving direction and a moving speed of the mobile terminal MTB. The detection result is supplied to a control module 13B.

Meanwhile, the control module 13B is provided with a position computation module 135. The computation module 135 activates the detection module 18 from a time point the signal from the GPS satellite ST cannot be received by the GPS reception module 16. At every time when an change in the moving direction or the moving speed is detected by the detection module 18, the computation module 135 stores the moving direction and the moving speed in the RAM 17 by associating the change with the detection time. When the QR code is input, the computation module 135 calculates the current position of the mobile terminal MTB, namely, the installation position of the IP-PBX equipment BTA based on moving directions and moving speeds of a plurality of times stored in the RAM 17.

As mentioned above, according to the second embodiment, since the current position of the mobile terminal MTB, namely, the installation position of the IP-PBX equipment BTA can be obtained by utilizing the detection result of the moving direction and the moving speed by means of the detection module 18 of the mobile terminal MTB, even in an environment in which the mobile terminal MTB cannot be connected to the network NW and the base station BS, the communication system may register the installation position of the IP-PBX equipment BTA in the maintenance center MC without any help from somebody.

### Other Embodiment

The invention is not limited to each of the embodiments of the above. For instance, while each of the embodiments has been described the example using the QR code as the identification information, the invention is not limited to the examples, a system for connecting the equipment through the Bluetooth or USB other than the displayed identification information such as the QR code to extract and transmit a unique code of the equipment, or a correspondence table generation means for reading unique code information of the equipment from a certain product to link MAC address information to position information is possible.

Further, the acquisition procedure and its content of the position information, the configuration and operation content of the communication system, the kind and its configuration of the terminal apparatus such as the mobile terminal, the stored content of the database, and the kind of the communication equipment such as the IP-PBX equipment, etc., may be embodied in various modified forms without departing from the spirit or scope of the general inventive concept thereof.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A terminal apparatus connectable to a maintenance center, via the communication network, wherein the maintenance center is connected to communication equipment via a communication network and performs maintenance work for the communication equipment, comprising:
a first acquisition module configured to acquire its own position information by using a known positioning system;
a second acquisition module configured to acquire its own position information through another system which is different from the positioning system, when an equipment ID specifying the communication equipment is input at an installation position of the communication equipment and when it is impossible for the first acquisition module to acquire the own position information; and
a transmitter which transmits a setting registration request including the equipment ID and the position information to the maintenance center via the communication network so that the maintenance center manages the equipment ID and the position information by associating them with each other, when the transmitter is connectable to the communication network.

2. The apparatus of claim 1, wherein
the second acquisition module acquires map information of surroundings of the communication equipment via the communication network to present the map information to a user, and generates the position information when the user inputs to specify a position on the map according to this presentation.

3. The apparatus of claim 1, wherein
the second acquisition module generates the position information based on a time interval and a moving direction and a moving speed of the apparatus, wherein the time interval is from a time point the position information is not acquired any more by the first acquisition module to a time point the equipment ID is input.

4. The apparatus of claim 1, further comprising:
a presentation module configured to present guidance information for inputting an installation position of the communication equipment to a user when position information is not acquired by the second acquisition module, wherein:
the transmitter transmits the setting registration request to the maintenance center via the communication network, when the user inputs installation position to the presentation through the presentation module based on the guidance information, and when the transmitter is connectable to the communication network.

5. A server apparatus provided for a maintenance center which is connected to communication equipment via a communication network and performs maintenance work for the communication equipment, comprising:
a receiver which receives a setting registration request reached from a terminal apparatus connected to the communication network via the communication network, wherein the setting registration request includes equipment ID specifying the communication equipment and installation position information of the communication equipment: and
a memory which associates equipment ID and installation position information included in the setting registration request received by the receiver with each other to store the association result.

6. A method for managing an installation position of communication equipment for use in a communication system, comprising a maintenance center which is connected to communication equipment via a communication network and performs maintenance work for the communication equipment; and a terminal apparatus connectable to the maintenance center via the communication network, comprising:
acquiring its own position information of the terminal apparatus by using a known positioning system when an equipment ID specifying the communication equipment is input at the installation position of the communication equipment;
acquiring its own position information of the terminal apparatus by using another system which is different from the known positioning system when the position information is not acquired in the known positioning system;
transmitting a setting registration request including the equipment ID and the position information to the maintenance center via the communication network, when the own position information is acquired and the terminal apparatus is connectable to the communication network;
receiving the setting registration request reached from the terminal apparatus via the communication network, by the maintenance center; and
associating the equipment ID and the installation position information included in the setting registration request with each other to store the association result in a memory.
